(19) United States
(12) Patent Application Publication
(10) Pub. No.: US 2026/0048813 A1
(43) Pub. Date: Feb. 19, 2026

(54) GEARBOX

(71) Applicant: Centre of Gears Ltd, Bristol (GB)

(72) Inventor: Oliver Ian Jukes, Bristol (GB)

(21) Appl. No.: 19/102,024

(22) PCT Filed: Aug. 25, 2023
(86) PCT No.: PCT/GB2023/052206

§ 371 Date: Feb. 7, 2025

(30) Foreign Application Priority Data
Aug. 26, 2022 (GB) 2212440.8

(51) Int. Cl. B62M 6/55; B62M 1/36; B62M 11/14

(52) U.S. Cl. CPC B62M 6/55; B62M 1/36; B62M 11/145

(57) ABSTRACT

Modern pedal cycle transmission systems comprise a chain and multiple sprockets, wherein the chain is moved between each sprocket by a derailleur. Whilst these systems are readily accessible by the user for maintenance, they are also prone to failure such as chain detachment or the derailleur mechanically failing. A gearbox for a bicycle is presented that addresses at least this problem, the gearbox 2 comprising an input gear 8 configured to receive a drive input and rotate about a first rotation axis in a first plane; an output gear 4 configured to rotate about a second rotation axis in a second plane different to the first plane; a plurality of drive transfer arrangements 26 intermediate the input gear 8 and output gear 4, each of the drive transfer arrangements 26 comprising a first gear 44 engaged with the input gear 8, a second gear 46 engaged with the output gear 4 and a shaft 58 therebetween, each drive transfer arrangement 26 configurable between a locked configuration whereby rotation of one of the first 44 and second 46 gears causes rotation of the other of the first 44 and second 46 gears such that drive between the input gear 8 and output gear 4 is enabled and an unlocked configuration whereby the first 44 and second 46 gears rotate independently of one another thereby disabling drive from the input gear 8 to the output gear 4; and a selection arrangement 71for selecting one of the plurality of drive transfer arrangements 26 and causing reconfiguration of the selected drive transfer arrangement 26 between the unlocked and the locked configuration.

The present invention relates to a gearbox suitable for both bicycles powered entirely by the rider or assisted bicycles such as those assisted by an electric motor.

Modern pedal cycle transmission systems comprise a chain and multiple sprockets, wherein the chain is moved between each sprocket by a derailleur. Whilst these systems are readily accessible by the user for maintenance, they are also prone to failure such as chain detachment or the derailleur mechanically failing.

One approach to overcome these shortcomings is the use of a gearbox transmission. Conventional gearbox arrangements utilise several gears, arranged axially along a plurality of shafts. These gears are selectively meshed with one another, axially over these shafts, to enable different gear ratios. The compounding effect of multiple gears over a single or multiple shafts leads to a long transmission chain and thus a bulky and heavy transmission system. Another embodiment of a geared transmission is a planetary gearbox, which can result in a more compact transmission, but is still heavy and can have a long drive train when multiple gear ratios are required.

It is desirable for pedal cycles to be lightweight, thus reducing their gravitational burden when travelling uphill and any frictional loses associated with increased weight. This makes the use of conventional geared transmission systems challenging as they add significant weight. Furthermore, due to the significant size they do not fit comfortably within a conventional pedal cycle frame meaning such frames often cannot accommodate more affordable derralieur transmissions as an alternative drivetrain option.

Aspects of the present invention seek to address the above-mentioned deficiencies or at least provide a useful alternative.

According to the present invention there is a gearbox for a bicycle comprising:
an input gear configured to receive a drive input and rotate about a first rotation axis in a first plane;
an output gear configured to rotate about a second rotation axis in a second plane different to the first plane;
a plurality of drive transfer arrangements intermediate the input gear and output gear, each of the drive transfer arrangements comprising a first gear engaged with the input gear, a second gear engaged with the output gear and a shaft therebetween, each drive transfer arrangement configurable between a locked configuration whereby rotation of one of the first and second gears causes rotation of the other of the first and second gears such that drive between the input gear and output gear is enabled and an unlocked configuration whereby the first and second gears rotate independently of one another thereby disabling drive from the input gear to the output gear;
a selection arrangement for selecting one of the plurality of drive transfer arrangements and causing reconfiguration of the selected drive transfer arrangement between the unlocked and the locked configuration.

The selection arrangement beneficially switches between the respective drive transfer arrangements meaning the drive transfer arrangement appropriate to the movement of the vehicle into which the gearbox is incorporated is selected. It will be appreciated that when a drive transfer arrangement is in the locked configuration so that the first and second gear simultaneously rotate drive between the drive input gear and drive output gear is enabled.

Interpretation of the term ‘drive’ when referenced to being enabled between the input gear and output gear means torque is transferred from the input gear to the output gear through the drive transfer arrangement that is in the locked configuration.

The first gear of each of the drive transfer arrangements is beneficially in the first plane and the second gear of each of the drive transfer arrangements is beneficially in the second plane.

The gear ratio of at least one of the drive transfer arrangements between the first and second gear is not 1:1. Each of the first and second gears on at least one (and preferably on each) of the drive transfer arrangements has a plurality of teeth for engaging with the respective input and output gears, where the number of teeth on the first gear is different to the number of teeth on the second gear.

The gear ratio between the first and second gear of a first drive transfer arrangement is different to the gear ratio of the first and second gear of a second drive transfer arrangement. This enables a difference in gear selection for a user.

The gear ratio of the input gear to the first gear is beneficially less than 1:1. It is beneficially significantly less than 1:1.

This can be adjusted depending on torque and speed requirements. An illustrative suitable ratio range is 6:1 to 10:1, even more preferably 5:1 to 9:1, and even more preferably 4:1 to 8:1 for first gear to last gear respectively. As an illustration the input gear may have approximately 80 teeth. This means that the first gear of the drive transfer arrangement has a higher angular velocity than the input gear. This means that the torque on the input transfer arrangement is less meaning the drive transfer arrangements can be smaller and lighter for a given input torque capacity.

The first gear of each of the drive transfer arrangements is beneficially constantly meshed with the input gear. The second gear of each of the drive transfer arrangements is beneficially constantly meshed with the output gear.

The second rotation axis is preferably different to the first rotation axis. The first axis and second axis are beneficially parallel to one another. The first gear and second gear of each of the drive transfer arrangements beneficially rotate about a common axis. In other words, the first and second gears of one of the drive transfer arrangements rotate around a common axis that is different from a common axis of rotation of a first and second gear of any other of the drive transfer arrangements.

The selection arrangement preferably comprises an actuator arrangement for causing reconfiguration of the selected drive transfer arrangement from the unlocked to the locked configuration. The selection arrangement also preferably comprises a controller for controlling the actuator arrangement. The controller may comprise a shifter for receiving a user input for transmitting a signal to the actuator arrangement to effect movement of the actuator arrangement. This movement causes the reconfiguration between the unlocked and locked configurations. The signal may be mechanical or electrical.

The selection arrangement is preferably configured such that only one drive transfer arrangement with a specific gear ratio is in the locked configuration at any one time. It will be appreciated that multiple drive transfer arrangements having the same gear ratio may be in the locked configuration at any one time.

Each of the drive transfer arrangements may comprise an individual actuator arrangement. In such an embodiment the individual actuator arrangements are preferably controlled by an electrical signal from the controller. Each of the actuator arrangements may comprise a solenoid.

The actuator arrangement may comprise a structure rotatably mounted relative to the plurality of drive transfer arrangements and being arranged to selectively cause reconfiguration of the selected drive transfer arrangement between the locked and unlocked configuration. The structure may be coaxial with the first rotation axis. The structure may comprise a plate.

The drive transfer arrangements are preferably arranged such that one of the first gear or second gear is secured relative to the shaft such that rotation of the respective first or second gear causes rotation of the shaft, and the other of the first or second gear is rotatably mounted relative to the shaft, the drive transfer arrangements further comprising a locking arrangement arranged to releasably engage and disengage the first or second gear that is rotatably mounted to the shaft from the shaft such that relative rotation is enabled when disengaged and disabled when engaged. In such an enabled configuration there is no drive from the input gear to the output gear.

The locking arrangement may comprise one or more locking elements for interlocking the shaft and the first or second gear into the locked configuration and a pin moveable between a first position where the locking elements are biased into engagement with the first or second gear and a second position where the locking elements are released from engagement with the first or second gear. The pin is preferably moveable longitudinally in the same rotation axis as the rotation axis of the first and second gear. The locking elements may be pawls.

Each of the locking arrangements may comprise a pin for moving the locking element(s), and where the actuator arrangement comprises a structure rotatably mounted relative to the plurality of drive transfer arrangements the structure comprises a plurality of recesses or abutments, where each of the recesses or abutments is paired with a corresponding pin so that in discrete rotational positions of the structure a paired pin is axially displaced upon engagement of the pin with the corresponding paired recess or abutment. In such a position none of the other pins are received into or upon their corresponding paired recess or abutment.

Alternatively, at least one of the first and second gear is axially moveable between the locked and unlocked configuration. A locking arrangement in the form of a dog clutch may be provided to effect locking between the first and second gear. The first and second gear may be positioned axially between the structure and a spring. The spring acts to return the first and second gears from the locked to the unlocked configuration. There may be first and second structures disposed axially on either side of the drive transfer arrangements, moveable to selectively activate one of the drive transfer arrangements between the locked and unlocked configuration. The first and second structures preferably comprise corresponding protrusions and/or recesses. It will be appreciated that one of the drive transfer arrangements means one or more drive transfer arrangements having the same gear ratio.

Under certain conditions and for certain applications gearboxes may require gear shifting capability under high torque conditions. This might occur when a user is climbing a steep hill and wants to quickly change gear without minimising their torque input. Accordingly, in such a situation the actuator arrangement may not be able to rotate to effect switching of the selected drive transfer arrangement from a locked to an unlocked configuration. As such, the actuator arrangement may be configured to axially deflect to a deflected configuration (under higher torque conditions), and there is further provided an abutment moveable with either the input or output gear where the abutment and the actuator arrangement are configured to abut in the deflected configuration and force the selected drive transfer arrangement into the unlocked configuration. It will be appreciated that when the abutment and actuator arrangement abut, the force may be mostly in the axial direction (due to geometry of the abutments ie ramps) and so forces the actuator arrangement to reverse the deflected portion thus forcing the return of transfer arrangement which is resisting axial movement. This effectively forces a gear change. The actuator arrangement may plastically deform to the deflected configuration or may shift as a whole axially away from the drive transfer arrangements. The abutment is preferably a shoulder that projects from the input or output gear which is adjacent to the actuator arrangement.

The input gear preferably comprises an input gear ring, and the output gear preferably comprises an output gear ring. Each of the input gear and output gear preferably comprise a plurality of engagement teeth. The teeth of the input and output gears may project radially inwardly or outwardly. Depending on the relative positioning of the input and output gears the gearbox can be either a hub gearbox or a direct crank driven gearbox.

The output gear is preferably fixedly connected to a plurality of teeth extending outwardly. These outwardly extending teeth transmit drive out of the gearbox to an external element. Preferably they are used to transfer drive from the gearbox to rear wheel of pedal cycle via a chain. Fixedly connected refers to rotation of the output gear resulting in associated rotation of a plurality of teeth. Further, fixedly connected refers to the output gear being co-axial relative to the plurality of outwardly extending teeth.

The input gear preferably comprises a coupling arrangement for coupling one or more shafts to the input gear to transfer a drive input to the input gear. The shaft(s) may be driven by crank arm and/or a motor. Optionally the input drive from a motor can be transmitted into the first gear of a drive transfer arrangement in an unlocked configuration, whereupon the drive is then transferred into the input gear. The input gear then transfers the drive into a different drive transfer arrangement in a locked configuration and then into the output gear. This may reduce the number of reduction stages required to transmit rotation from the electric motor to the gearbox.

The gearbox preferably further comprises a motor coupled to the coupling arrangement for providing supplementary drive to the input gear. The motor and gearbox are beneficially provided in a single housing.

Also according to the present invention there is a gearmotor for an electric bicycle comprising:
a gearbox as hereinbefore described;
a motor for providing drive to the input gear.

Further according to the present invention there is a powertrain for an electric bicycle comprising:
a gearmotor as hereinbefore described
a sprocket for mounting on a wheel of the bicycle;
a chain or drivebelt coupled to the output gear and sprocket for transferring drive from the output gear to the sprocket.

The motor may provide drive to the input gear by means of a reduction gear stage, or alternatively the motor may indirectly drive the input gear by providing direct drive or indirect drive via a shorter reduction gear stage to the first gear of one of the drive transfer arrangements. Accordingly, the gearbox may be arranged such that the motor provides direct drive to the first or second gear.

Aspects of the present invention will now be described by way of illustration only with reference to the accompany figures in which:

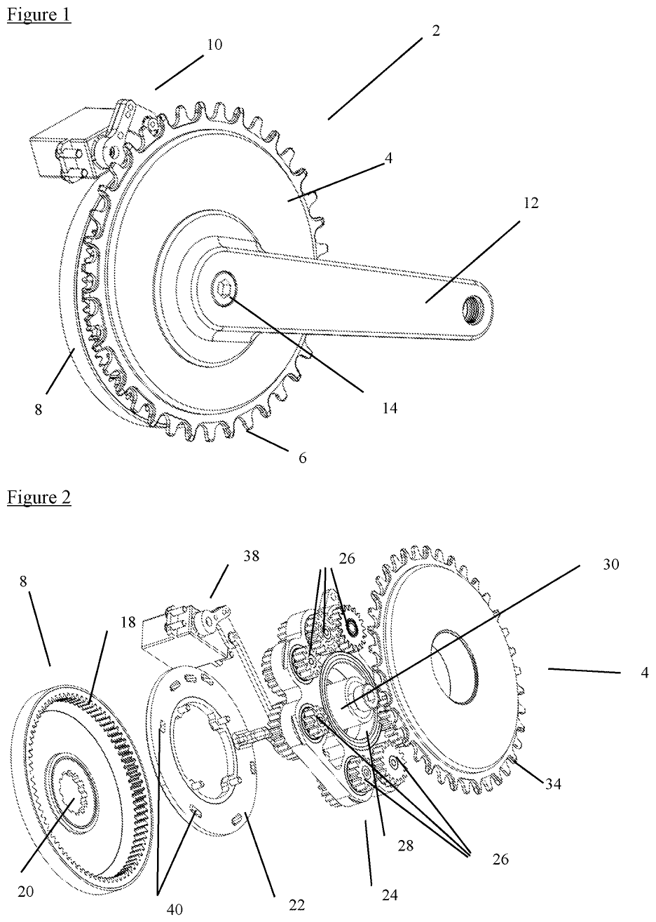

FIG. 1 is a schematic representation of a gearbox according to an illustrative embodiment of the present invention.

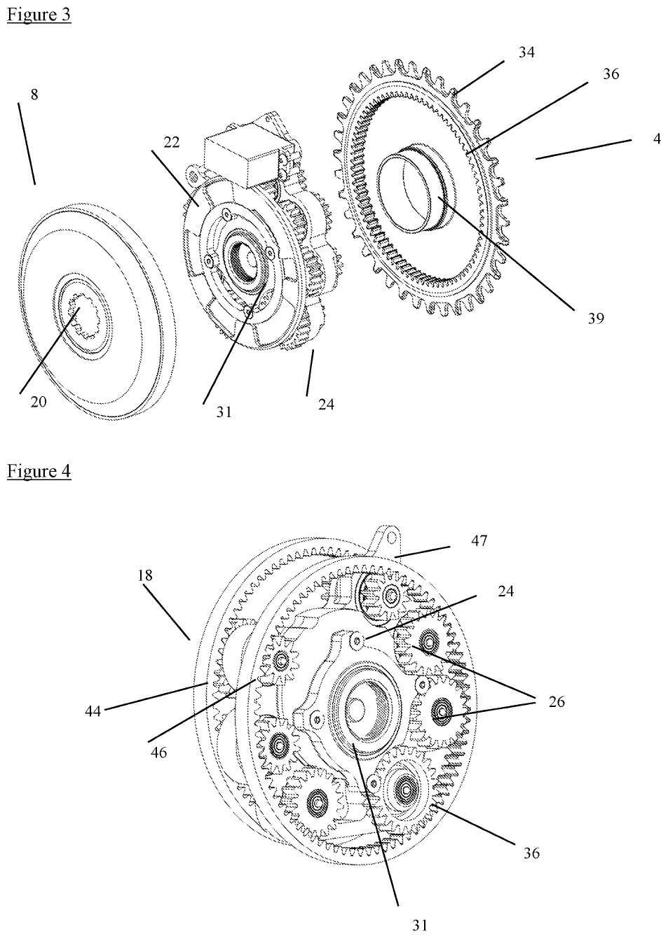

FIGS. 2-5 are exploded schematic representations of a gearbox according to an illustrative embodiment of the present invention.

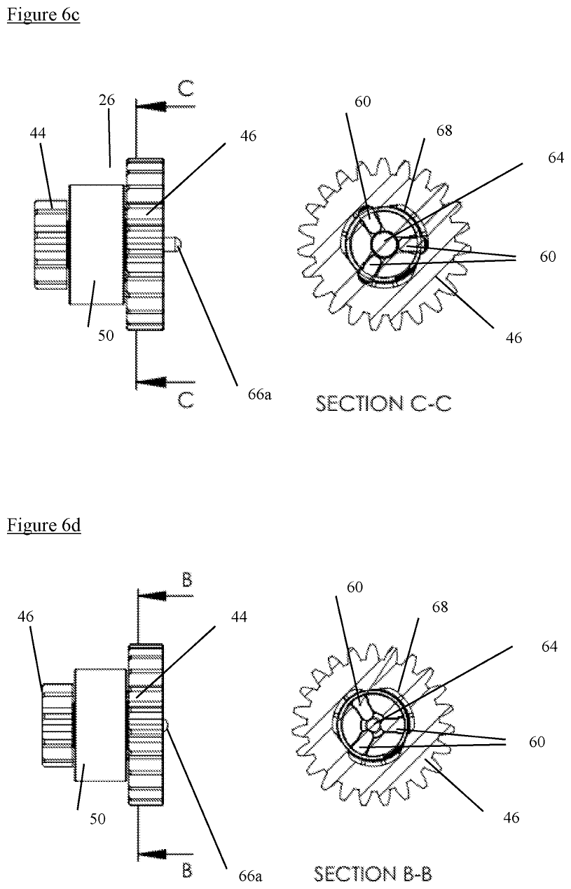

FIG. 6a-d are schematic illustrations of drive transfer arrangements present in an illustrative embodiment of the present invention in perspective, exploded and sectioned views, and FIGS. 6e-f are alternative drive transfer arrangements.

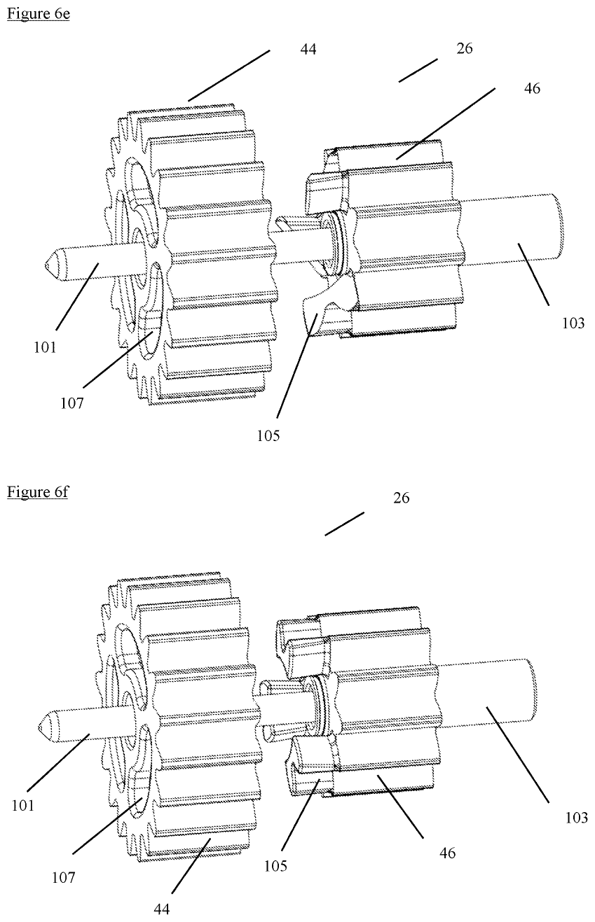

FIG. 7 is a schematic illustration of a actuator arrangement present in an illustrative embodiment of the present invention.

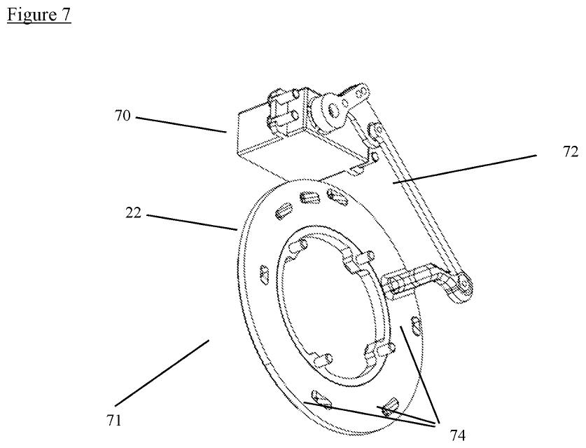

FIG. 8a and bare schematic perspective and exploded representations respectively of a motor and gearbox assembly according to an illustrative embodiment of the present invention.

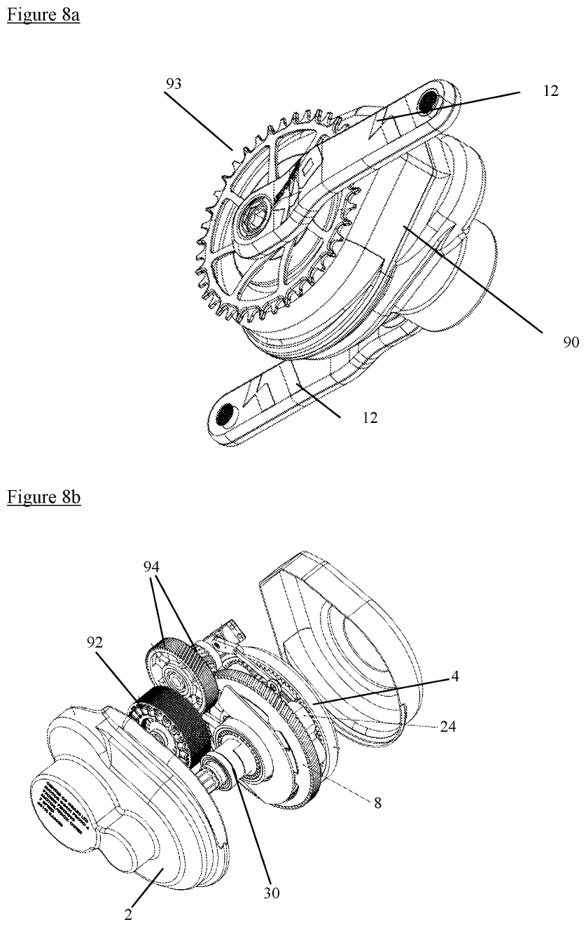

FIG. 9a and b are schematic perspective representations of an illustrative embodiment of the present invention.

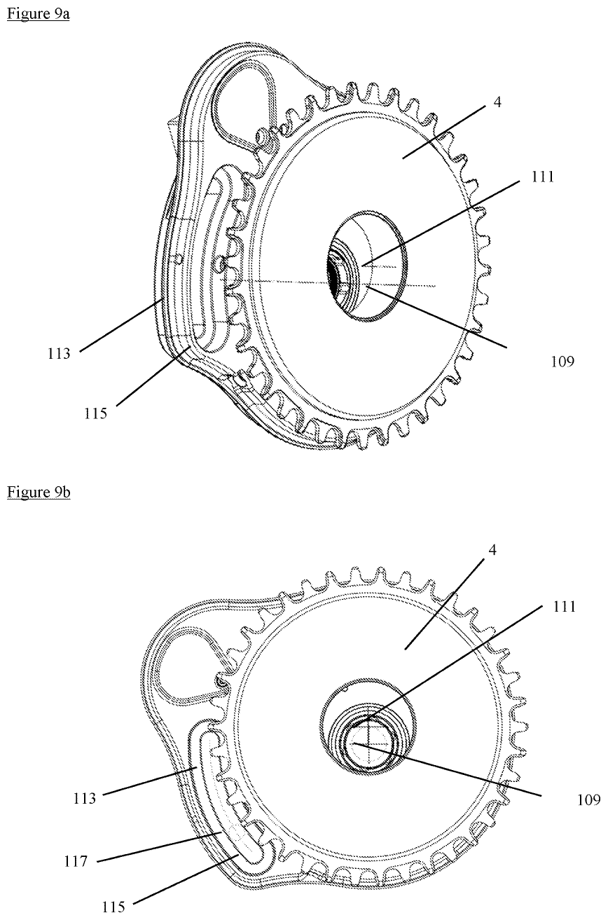

FIG. 10 is a schematic perspective view of a hub gearbox according to an illustrative embodiment of the present invention.

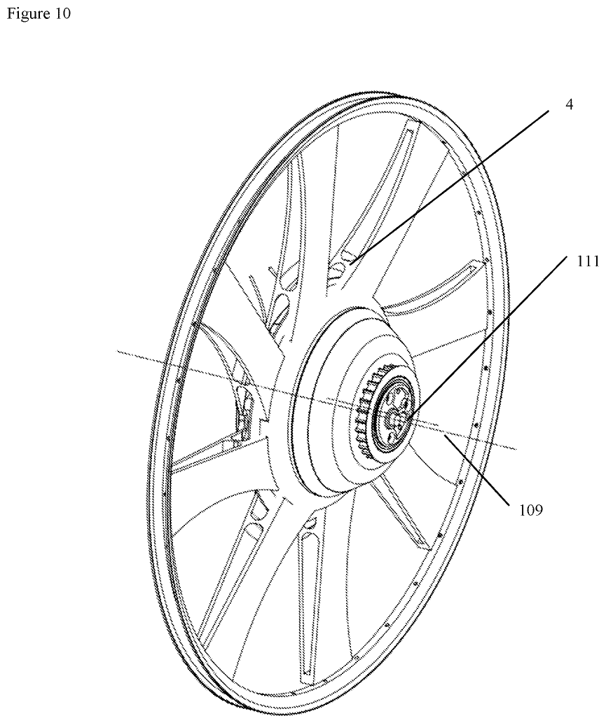

FIG. 11 is a schematic exploded view of a hub gearbox according to an illustrative embodiment of the present invention.

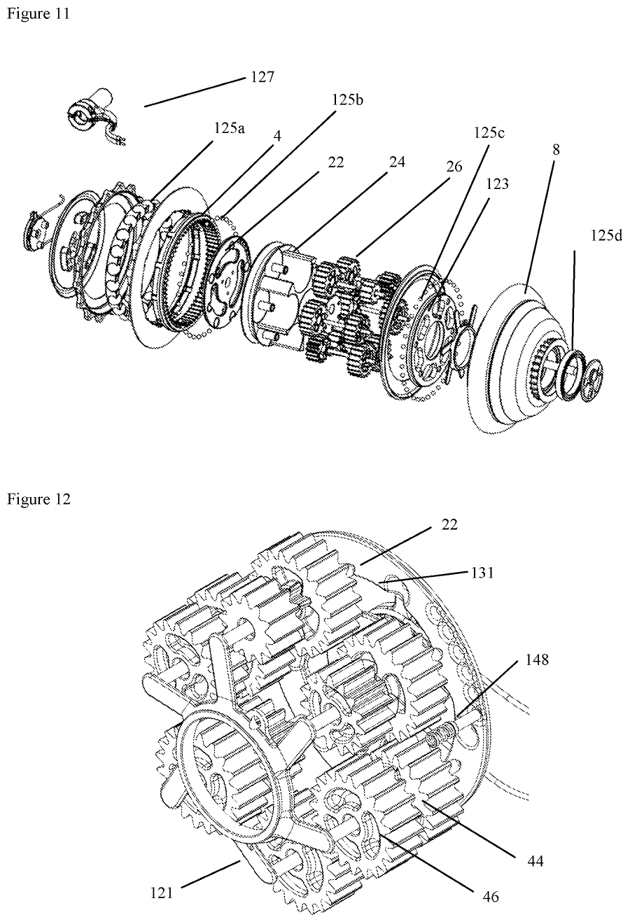

FIG. 12 is a schematic representation of part of an illustrative embodiment of the present invention.

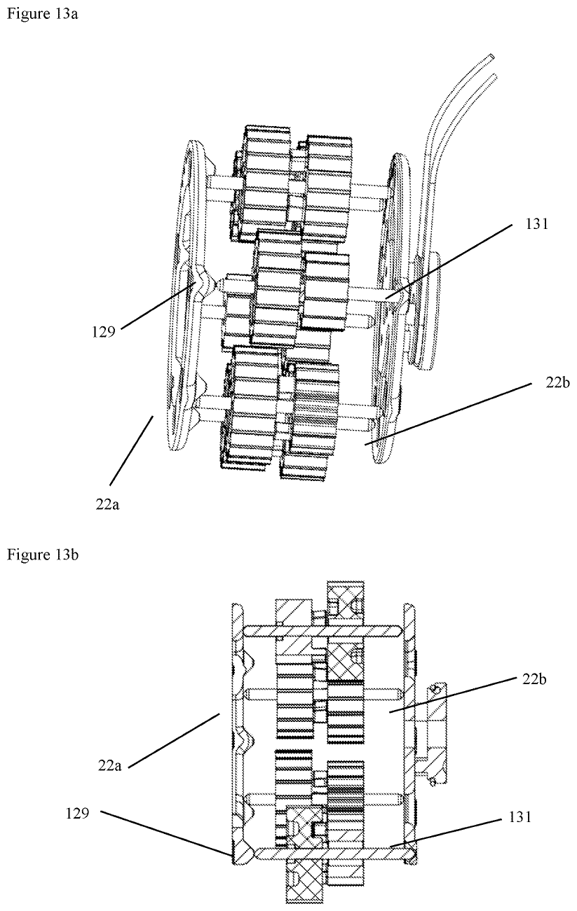

FIG. 13a and b are schematic representations of parts of an illustrative embodiment of the present invention.

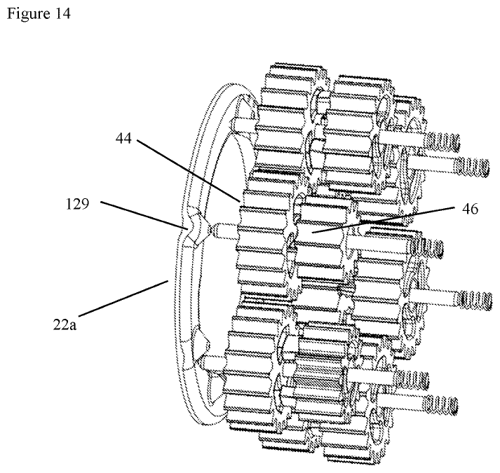

FIG. 14 is a schematic representation of parts of an illustrative embodiment of the present invention.

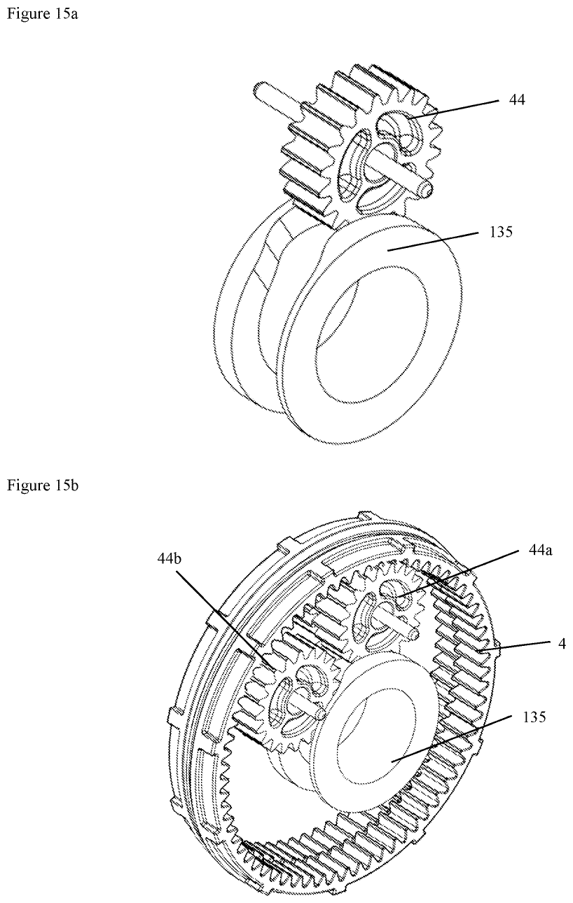

FIG. 15a and b are schematic representations of parts of an illustrative embodiment of the present invention.

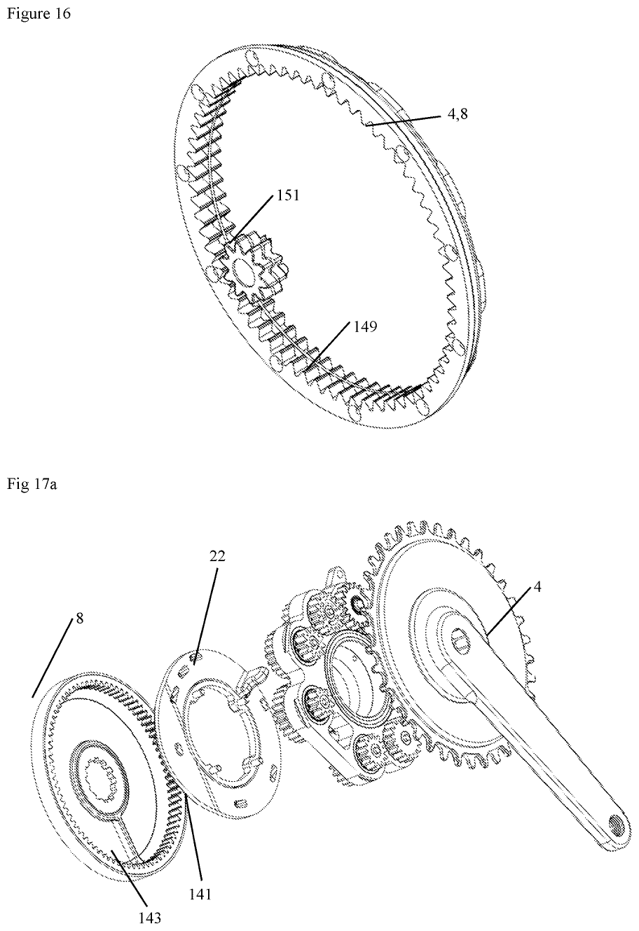

FIG. 16 is a schematic representation of part of an illustrative embodiment of the present invention.

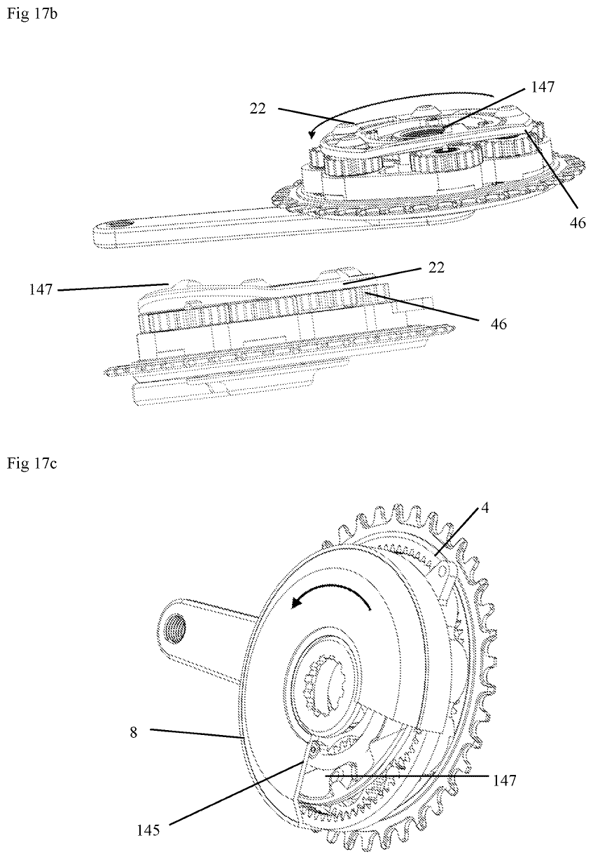

FIG. 17a-c are schematic representations of an illustrative embodiment of the present invention.

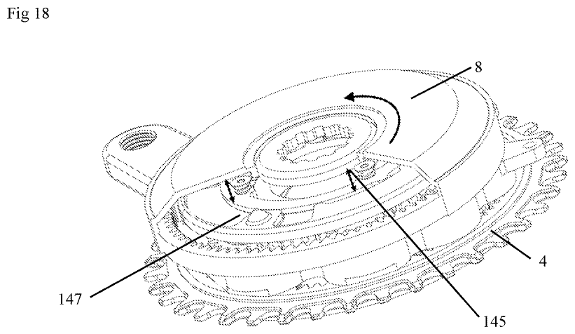

FIG. 18 is a schematic representation of an illustrative embodiment of the present invention.

Referring to FIG. 1 there is a gearbox 2 according to an illustrative embodiment of the present invention. FIG. 1 shows the external components of the gearbox in the form of an output gear formation 4 which carries an output gear internally and additionally comprises a plurality of outwardly facing teeth 6. Further provided is an input gear formation 8 which carries an input gear and a housing 10 that houses components of a actuator arrangement-which enables selection of which “gear” is to be used by the operator-and a carrier-which carries a series of drive transfer arrangements. The gearbox 2 is connected to a pedal crank arm 12 via a fixing bolt 14. It will be appreciated that the axial thickness of the gearbox is relatively small and may be mounted in place of a traditional crank arm and chain ring on a conventionally designed bicycle frame without the requirement for modification of the frame or design of a custom frame configuration. Accordingly, the gearbox 2 can be mounted to an existing bicycle frame thus removing the requirement for a traditional derailleur.

Referring to FIG. 2 there is an exploded view of a gear box 2 according to an illustrative embodiment of the present invention. In this figure the crank arm 12 has been removed together with the housing 10 for clarity purposes. An input gear formation 8 carries an input gear having a plurality of inwardly facing gear teeth 18. The input gear formation 8 further comprises a coupling formation 20, for example a plurality of splined teeth, that is designed to couple with a pedal crank shaft and/or a motor which provide the drive to the input gear formation 8. The input gear formation 8 is driven about an axis of rotation through the centre of the ring.

Adjacent to the input gear formation 8 is an selector plate 22 which forms part of a actuator arrangement which will be described in more detail later. Axially adjacent to the selector plate 22 is a carrier 24 which is arranged to carry a plurality of drive transfer arrangements 26. In the embodiment presented there are eight drive transfer arrangements 26 meaning that the gearbox provides eight individual gear ratios for a user. It will be appreciated that the number of drive transfer arrangements 26 can be modified dependent upon the number of individual gear ratios required. A bearing 31 is provided for receipt of the input shaft 30 where the input shaft 30 receives input from the crank arm 12 and/or the motor if present. The input shaft 30 extends through, supported by the bearing 31, to couple to a motor. Optionally, in addition to or alternatively the input shaft 30 could couple to the coupling formation 20 of the input gear formation 8.

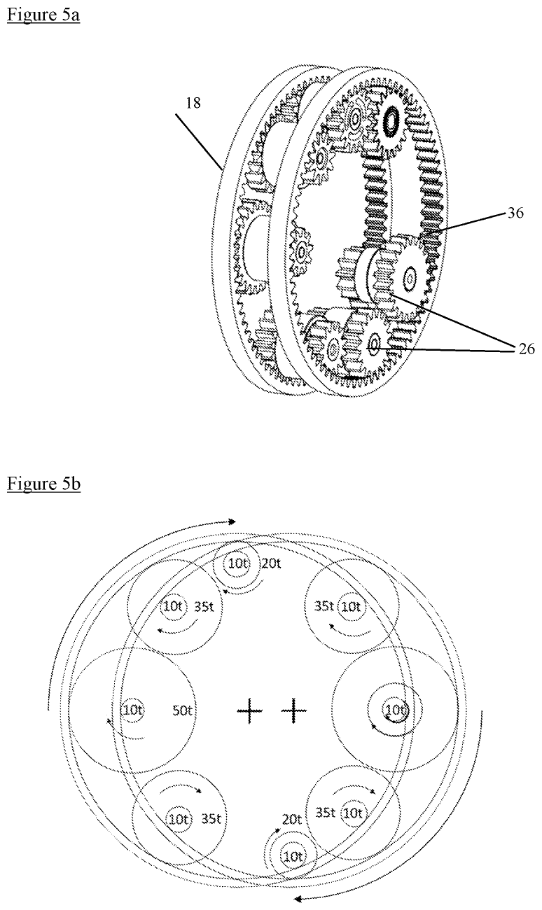

Axially and outwardly of the carrier 24 is the output gear formation 4comprising a plurality of outwardly facing teeth 34 which communicate via a chain or belt to engage with a sprocket forming part of the rear wheel of the bicycle. The output gear therefore provides the link to drive the rear wheel. The output gear formation 4 also comprises an output gear with a plurality of radially inwardly facing teeth 36 which are more clearly shown in FIG. 3 when the exploded gearbox 2 is rotated such that the inner surface of the output gear formation 4 is visible.

When assembled it will be appreciated that the teeth 18 of the input gear are in constant engagement with the drive transfer arrangements 26, and the inner teeth 36 of the output gear also are in constant engagement with the drive transfer arrangements 26. Thus, each drive transfer arrangement provides a selectable pathway for drive from the input gear to the output gear. It will subsequently be described in more detail how drive passes through a single drive transfer arrangement 26 to provide a distinct gear for a user. It will also be understood that the selection plate 22 enables selection of one of the drive transfer arrangements 26 to be activated meaning drive passes through this drive transfer arrangement 26. It will be appreciated that drive will pass through one distinct drive transfer arrangement 26 at a time, and that the selection plate 22 causes this to occur. The selection plate 22 can be operated by virtue of a servo motor 38 that effects actuation of the selection plate22. The servo motor 38 selection plate 22 together with the controller in the form of a shifter (not shown) in part comprise the selection arrangement.

Referring now to FIG. 3, an alternative exploded view of the gearbox is presented where the gear teeth 36 of the output gear are also presented extending radially inwardly in the output gear formation 4 and where the teeth 34 are also shown for transmitting drive to the rear wheel. The output gear formation 4 further comprises a flange 39 integral with the output gear formation 4 where the flange is configured to insert into the bearing 28 which is best shown in FIG. 2 about which the output gear formation 4 rotates. The bearing 28 is held in the carrier 24. The input shaft 30 which is presented in FIG. 2 is not shown in FIG. 3 however this extends through the flange 39, through the bearing 28 and is then supported by bearing 31 which is axially parallel but offset relative to bearing 28. The input shaft then couples to an electric motor. The selection plate22, which is in the form of a disc and is coaxial with the input shaft (and first rotation axis), has a plurality of indents 40 as shown in FIG. 2 is also clearly visible including the servo motor 38. As will be described in more detail the servo motor 38 enables rotation of the selection plate 22 which means that different drive transfer arrangements 26 can be selected and locked so that drive is transferred through the selected drive transfer arrangement.

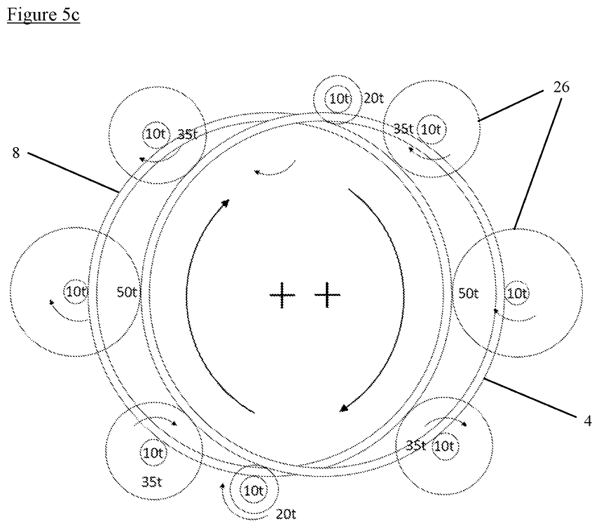

The assembly of the gearbox is further schematically presented in FIG. 4 in an assembled configuration. For clarity purposes only the output gear and its plurality of teeth 36 of the output gear formation 4 have been represented, as have the input gear and its plurality of teeth 18 of the input gear formation 8. The carrier 24 is clearly visible showing the plurality of drive transfer arrangements 26. Each drive transfer arrangement comprises first and second gears 44,46 which correspondingly engage with the input gear teeth 18 and output gear teeth 36 respectively. In order to achieve different gear ratios each of the first gear 44 and second gear 46 are different in each of the drive transfer arrangements. In a locked configuration whereby rotation of the input gear formation 8 causes associated rotation of the first gear 44 then the second gear 46 will also rotate causing associated rotation of the output gear formation 4. In an unlocked configuration the first and second gears 44,46 rotate independently of one another meaning that there is no drive from the first gear 44 to the second gear 46 and thus there is no drive from the input gear formation 8 to the output gear formation 4. Each of the first gear and second gear are constantly meshed with the input gear and its plurality of teeth 18 and the output gear and its plurality of teeth 36 meaning that it does not matter which drive transfer arrangement 26 is in the locked configuration, there is permanent rotation of each of the first and second gears 44,46.

More clearly shown in FIG. 4 is the provision of an arm portion 47 of the carrier 24. This arm portion 47 can be utilised to rotate about the fixed first axis and then fix the entire carrier relative to the bicycle frame. As the output gear formation 4 is mounted eccentrically relative to the input shaft then the position of the output gear formation 4 relative to the frame in which the gearbox is mounted can be adjusted. This means that the chain or belt can be tensioned without requiring other tensioning devices or specific frame design.

Further referring to FIG. 4 it is apparent that the input gear and its plurality of teeth 18 and the output gear and its plurality of teeth 36 are in first and second planes respectively where the planes are different to one another. They are effectively in a side-by-side configuration with the carrier 24 therebetween. Accordingly, the thickness or width of the gearbox is extremely narrow which means that the gearbox can firstly be integrated into an existing and standard bicycle with no modification of the frame. Secondly, this means that such a gearbox can be positioned in a side-by-side configuration with respect to a motor meaning that the width of the entire motor/gearbox assembly is minimised.

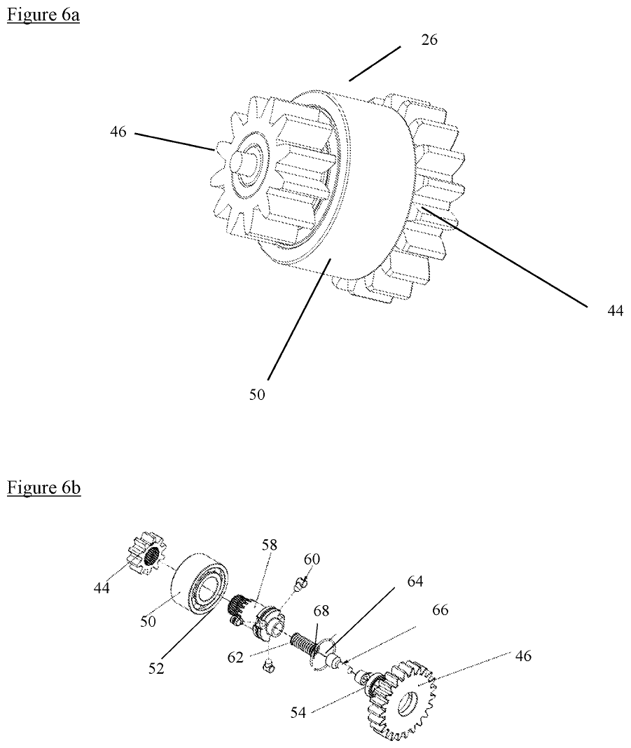

FIG. 5a is a further illustration with additional components having been removed. This is presented to simply show the input gear and its plurality of teeth 18, output gear and its plurality of teeth 36 and in illustrative embodiment seven of the drive transfer arrangements 26. Other components such as the carrier and actuator arrangement have been removed for clarity purposes. FIG. 5 clearly illustrates the low axial width of the gearbox as well as shows the drive transfer arrangements 26 in some more detail. The drive transfer arrangements and the first and second gears respectively 44,46 each have different numbers of teeth to provide different gears to the user. It will be appreciated, for example, that by providing the first gear with many teeth in relation to the second gear with fewer teeth a low gear is provided whereby the input speed of the input gear formation 8 is high relative to the low output speed of the output gear formation 4. The converse is true for other drive transfer arrangements 26.

Referring to FIG. 5b an arrangement is presented whereby one of the first or second gears 44, 46 is driven by an electric motor 47. In this instance, the motor benefits from a naturally occurring reduction stage. Further shown in this illustration is the provision of identical first and second drive transfer arrangements 26 which serve to increase peak torque capacity. This is beneficial in some applications.

FIG. 5c is an illustration of an arrangement whereby the drive transfer arrangements are disposed externally of the input and output gear formations 8,4.

Referring now to FIGS. 6a to 6d an illustrative drive transfer arrangement 26 is presented. The drive transfer arrangement 26 comprises the first gear 44 and second gear 46 each having a plurality of teeth. Shown in FIG. 6a is a bearing 50 about which a shaft 58 rotates. Referring now to FIG. 6b, the shaft rotates within this bearing and one of the gears 44,46 is fixedly connected to the shaft which may be, for example, via a plurality of splines 52. This means that one of the first or second gears 44,46 is fixed relative to the shaft and therefore must rotate along with the shaft 58. In the embodiment shown the fixed gear will be referred to as the first gear 44. The second gear 46 is also mounted to the shaft 58 via a bearing 54 which allows the second gear 46 to rotate relative to the shaft 58 in an unlocked configuration. A locking arrangement is provided which may comprise pawls 60 which are retained within the body of the shaft 58. Other components that are present are a spring 62 and a transfer pin 64, where the transfer pin 64 comprises a first region with a first radius 66 and a second region with a second radius 68. The second radius 68 is larger than the first radius 66.

Referring now to FIG. 6c in combination with FIG. 6b, the drive transfer arrangement 26 is in the locked configuration where the spring 62 applies a force to the rear of the transfer pin 64 causing it to protrude outwardly from the leading face of the second gear 46. This protrusion 66a brings the second region 68 of the transfer pin 64 into contact with the rear of the pawls 60 forcing them radially outwardly from the shaft 58. In this configuration therefore the pawls 60 are engaged into corresponding apertures 68 the internal surface of the second gear 46 meaning that the second gear 46 cannot rotate relative to the shaft 58 about the bearing. In this configuration therefore drive is transmitted from the first gear 44 to the second gear 46.

Referring now to FIG. 6d, the drive transfer arrangement 26 is in an unlocked configuration whereby the protrusion 66a is no longer extending significantly from the leading face of the second gear 46 meaning that the transfer pin 64 has been pushed inwardly against the force of the spring 62. This means that as a result of the first region with the first radius now in communication with the pawls 60, the pawls fall out of engagement with the recesses 68 and rotation of the second gear 46 is now allowed meaning that the drive transfer arrangement 26 is now in the unlocked state. The drive transfer arrangement is biased towards the locked state however at any one time only one of the drive transfer arrangements can be in the locked state. The remaining drive transfer arrangements are in the unlocked state and in the embodiment presented the transfer pin 66 must therefore be deflected into the compressed configuration as shown in FIG. 6d. This means as soon as the transfer pin 64 can release into the configuration of FIG. 6c, engagement and drive through this drive transfer arrangement 26 will be enabled.

Referring to FIG. 6e alternative drive transfer arrangements are presented whereby there is axial movement of one of the first or second gears 44, 46 relative to the other of the first or second gear between the locked and unlocked configuration. The type of drive transfer arrangements presented are known as dog clutches. The gear pair 44, 46 is disengaged when moved axially apart and engaged when moved axially together. In this instance, the gear pair 44, 46 remain in constant mesh with the main input and output gears 4,8 by only partially offseting from the main input and/or output gears. The dog clutches provide a significantly increased amount of material and increase load transmission when using softer materials in the gearbox construction (e.g. polymers). In the embodiment presented the first gear 44 is rotatably mounted to a first shaft portion 101 (although this configuration can be reversed) in a fixed axial position, and the second gear is rotatably mounted to a second shaft portion 103 in a fixed axial position, whereby the first and second shaft portions 101, 103 are moveable axially relative to each other. In an unlocked configuration where the gears are axially spaced they can rotate independently of each other, whereas in a locked configuration drive where the gears engage with each other drive is transferred between the first and second gear. In this embodiment the locking arrangement comprises corresponding projections 105 and recesses 107 arranged to engage with one another, engagement may be maintained by angled or hooked elements belonging to the thrust face in projections 105 which create a joining force between the gears 44 & 46 in the axial direction which may counter any unwanted axial forces which may pose unwanted clutch disengagement. To a similar effect, gear tooth profiles may be helical and oriented to so generate an axial force in the direction which promotes clutch engagement. Axial movement is enabled by virtue of the actuator arrangement such as the selector plate 22 as described above. The selector plate biases against one of the first or second shaft portions and compresses a spring (not shown in the schematic Figure) and forces the gears into engagement. Upon release of the selected gear by movement of the selector plate 22 the spring (not shown) biases the gears apart. Further operation of this illustrative embodiment of a drive transfer arrangement will be described with respect to FIGS. 12 and 13 for example. The embodiment of FIG. 6e may be termed a one way dog clutch whereby the wedged dog feature (locking arrangement) is unable to transmit reverse torque and therefore offers a ratcheting effect. In this instance, the applied torque will force the gear pair apart and simply compress the spring which encourages engagement. This embodiment enables the selected drive transfer arrangement and therefore the whole gearbox to also act as a freewheel.

Referring to FIG. 6f this embodiment may be termed a two way dog clutch due to the configuration of the locking arrangement, whereby the clutch may transmit reverse torque. In this instance the clutch may transmit reverse torque for applications such as regenerative braking. This embodiment also prevents two partially engaged ratios from fighting one another, this is particularly useful when actuation of ratio shifting is slow, momentarily causing engagement of two transfer arrangements simultaneously.

A mechanism for enabling selection between the individual drive transfer arrangements to cause reconfiguration of the selected drive transfer arrangement between the unlocked to locked configuration may be achieved in various ways. In the illustrative embodiment as presented in FIG. 7, an actuator arrangement 71 is utilised comprising a selection plate 22 which is activated via a servo motor 70 through a linkage 72. Both the servo motor and linkage cause stepwise rotation of the selection plate 22 between various rotational states. The selection plate comprises a plurality of selection slots 74. The slots are in a third plane which is different to the first and second plane occupied by the input gear and its plurality of teeth 18 and output gear and its plurality of teeth 36 (and accordingly the first and second gears 44,46). The selection plate 22 further rotates about the same axis as the input gear formation 8. As the servo motor 70 rotates the selection plate 22 the protruding portion 66a of the transfer pin 64 either engages or disengages with a respective selection slot 74 depending upon the degree of rotation. The selection slots are chamfered to allow ease of location and exit from the respective selection slots. This means that after or as one transfer pin 64 starts to become disengaged, engagement occurs with a transfer pin of a different drive transfer arrangement with a different selection slot. The plurality of selection slots 74 are arranged at different radial distances from the rotation axis due to the second gear of each drive transfer arrangement having a different number of teeth beneficially resulting in each selection slot having a different pitch circle diameter and therefore being able to engage only with any one transfer pin 64 which is arranged on the same pitch circle diameter. Due to each drive transfer arrangement having a different gear ratio, this will naturally occur at different pitch circle diameters. Consequently, each transfer pin 64 can only enter or exit a single selection slot 74.

In an alternative embodiment, the mechanism for reconfiguring the individual drive transfer elements could instead comprise an electronic actuator, such as a solenoid. This solenoid would control the position of the transfer pin 64 replacing the need for the reaction force provided by the spring 62 and the actuation force provided by the selection plate 22. Consequently, the disclosed alternative embodiment would have an actuation arrangement comprising a solenoid, that would replace the need for the servo motor 70, selection plate 22 and linkage 72 disclosed in the illustrative embodiment shown in FIGS. 1-8.

In a further alternative embodiment, actuation of the stepwise rotation of the selection plate 22 could be achieved through a traditional mechanical cable system actuated by a controller in the form of a mechanical shifter as opposed to via a servo motor.

It will be appreciated that alternative arrangements may be provided to enable locking and unlocking of the drive transfer arrangement 26. For example, individual solenoids for each drive transfer arrangement may be provided to actuate the transfer pins to select and deselect locking of that particular drive transfer arrangement. Such solenoids may be electronically controlled via an electronic controller from a handlebar mount by a user for example.

Reference is now made to FIG. 8a and b which show a gearbox according to an illustrative embodiment of the present invention combined with an electric motor to provide a motor gearbox assembly. The motor gearbox assembly 90 may be provided in a single housing and as shown with a drive input also optionally transferred via the crank arms 12. The output toothed ring 93 is shown external of the assembly. This is then connected via a chain or belt to a sprocket mounted on the rear wheel of a bicycle.

Referring to FIG. 8b, the electric motor 92 transfers drive through a series of helical gears 94 to the input shaft 30 which cooperates via the coupling formation 20 in the input gear formation 8 and then output gear formation 4. It will be appreciated that the drive transfer pathway between the motor and input gear formation 8 could take another form, an example of which being the motor directly engaging with the first gear 44 of a drive transfer arrangement 26. The figure is schematic in nature meaning the output gear formation 4 will then be connected (or integrally formed) to a further toothed ring 93positioned outside the casing for onward connection to the rear sprocket. By virtue of the small axial width of the gearbox side-by-side mounting of the motor and gearbox is enabled. Furthermore, a significant advantage of coupling the gearbox according to the present invention with a motor is that due to the high rotation speed of the motor multiple helical gears are required in order to provide an output speed suitable to the desired application. By utilising the present invention, however, the number of helical gears can be reduced.

Referring to FIG. 9a and b, the embodiment of FIG. 1 is shown without the pedal crankshaft. This shows the first and second rotation axes 109,111 offset relative to each other meaning that the gearbox can be rotated relative to the bicycle frame and the eccentric mounting of the output gear relative to the frame enables tensioning of the chain or belt that connects to the rear sprocket that drives the rear wheel. Thus, the second axis is not fixed relative to the frame. The gearbox is secured relative to the frame by a fixing that fixes a mounting formation 113 such as an elongate slot 115 that is curved to have a common centre with the first rotation axis. This means that the gearbox and thus the output gear can be rotated to accurately tension the chain or belt.

The gearbox, and particularly the mounting formation, provides a useful torque reaction point 117 that can be used to determine the torque being applied to the input gear. Accordingly, a sensor may be provided to provide an output indicative of the torque being applied to the input gear. From the sensor output and known ratio selected, a torque can be determined and/or a pedal assist signal may be provided to a motor if present for control of the input torque from the motor. The sensor may be internal and take the form of a strain gauge suitably positioned and calibrated to detect the applied range of torque. Alternatively, the torque sensor may be external and belong to a corresponding torque reaction linkage which is attached to the bicycles frame.

Referring to FIG. 10 a complete wheel assembly which comprises the sealed internal gearbox and internal drive transfer arrangements configured for unidirectional torque transfer. By each drive transfer arrangement having its own drive ratio and ratchetting dog clutch for example, the wheel can produce an audible and familiar freehub sound comparable with other bicycle freewheels, but with a key difference being that the audible frequency is changed when a new ratio is selected. This gives the rider an audible indication of which gear they are in. Like as described with respect to FIG. 9, the main axis (first rotation axis) of rotation of the wheel is fixed by the bicycle frame dropouts and the belt/chain pulley's axis (second rotation axis) is movable to adjust belt/chain tension. It will be appreciated that the difference between a hub gearbox and a crankshaft mounted gearbox is that in the hub gearbox of FIG. 10 the input gear is the outermost gear and the output gear the innermost gear. This is further shown in FIG. 11.

Referring to FIG. 11 an illustrative embodiment of the invention is presented comprising an exploded view of a hub gearbox where the selection plate 22 may be cable actuated to effect selection between the six drive transfer arrangements 26. As described with respect to earlier embodiments the individual drive transfer arrangements are retained by a carrier 24. In this embodiment the drive transfer arrangements are those as described with respect to FIG. 6e or 6f where there is axial displacement of one of the gears 44,46 into and out of engagement with the other of the gear 44,46 dependent upon the position of the selection plate 22. A leaf spring or spider spring 121 is provided to act against the selection plate 22 and therefore disengage the gears 44,46 as another gear is selected. Further shown in the exploded view is an axle support plate 123, bearings 125a, b, c & d and shifter 127. Also shown is a seal face which attaches output gear 4 which remains in sliding contact with a counter seal feature which is attached to input gear 8. It is possible to manufacture the components of this embodiment from polymeric materials.

Referring to FIG. 12, drive transfer arrangements 26 are presented that are particularly suitable for a polymer gearbox with a cable actuated shifter disc. The two cables shown provide a means of shifting both ways without a return spring. A single cable and return spring or directly mounted shifter lever are alternatives. In this instance, a remote twist shifter with twin cables can be utilised. In this embodiment there is a return spring which preferably takes the form of a leaf spring or spider spring 121. In the embodiment represented, the concave feature 131 in selection plate 22 aligns with a portion of the shaft of the middle gears as shown in FIG. 12 and effects axial displacement of a gear such that the gears 44,46 are locked together whilst remaining in engagement with the input and output gears. This spring engages any shaft of a specific drive transfer arrangement 26 which the selection plate 22 allows and therefore the selection plate 22 may forcibly disengage a given transfer arrangement and the spring 121 may rapidly engage the next ratio selected. The spring is preferably positioned with the first and second gear positioned axially between the selection arrangement in the form of selection plate 22 and spring. It will be appreciated that any known type of spring may be used, for example a coil spring. Also shown in FIG. 12 is a spring-loaded locator pin 148 which promotes stepped positioning of the selector plate 22 which in turn increases gear shifting precision and improves user feedback in the form of an easily detectable click. Increased spring stiffness in each transfer cassette may offer a similar affect.

Referring to FIG. 13a and b another illustrative embodiment is present. In this embodiment there is no return spring required to return the gears 44,46 from the locked to the unlocked configuration. Instead, there are first and second structures (selection plates 22) disposed axially on either side of the drive transfer arrangements 26. When a gear is switched, the remote shifter 127 rotates both of the selection plates 22a, b. The second selection plate 22b has convex features 129 instead of grooves and obviates a return spring. In this instance, both shifter discs must be mechanically synchronised (not modelled). The opposing concave 131 and convex 129 features of the shifter disc pair control the axial position of a gear of a drive transfer arrangement 26. In the embodiment represented, the convex feature biases against a portion of the shaft of the middle gears as shown in FIG. 13a and effects axial displacement of a gear such that the gears 44,46 are locked together whilst remaining in engagement with the input and output gears (not shown)

Referring to FIG. 14 another illustrative embodiment is present. In this embodiment there are individual return springs on the opposite side which return the gears 44,46 from the locked to the unlocked configuration. The (selection plate 22a) is disposed axially on the opposite side of the drive transfer arrangements 26. When a gear is switched, the remote shifter 127 rotates the selection plate 22a. In the embodiment represented, the convex 129 feature biases against a portion of the shaft of the middle gears as shown in FIG. 14 and effects axial displacement of a gear such that the gears 44,46 are locked together whilst remaining in engagement with the input and output gears (not shown).

Referring to FIG. 15a and b a push/pull shifter barrel is shown which has a similar effect to the embodiment shown in FIG. 13a and b and obviates a return spring and is used as the actuator arrangement. In this embodiment this actuator 135 replaces the selection plate 22. The gear 44a is in the engaged configuration, and the gear 44b is in the disengaged configuration. A similar narrower version could also be received within a groove on the laterally movable gear or shaft.

Referring to FIG. 16 in any of the embodiments presented the input gear and/or output gear 4,8 depending on the gearbox configuration may comprise an annular rib which increases the peak torque capacity. This is particularly beneficial when manufacturing the input/output gears and gears of the drive transfer arrangements from polymeric materials. The corresponding gear features a central groove 151 to accept the ribbed feature. Optionally we can provide multiple grooves and ribs to increase tooth strength and the grooves/ribs may be positioned anywhere laterally along the gear face. The groove and rib may also be used to limit the axial position of a gear used for dog clutch embodiments. It will be appreciated that the rib could instead be located on the gear, with the corresponding groove on the input/output gear.

Under certain conditions and for certain applications gearboxes may require gear shifting capability under high torque conditions. This might occur when a user is climbing a steep hill and wants to quickly change gear without minimising their torque input. Accordingly, in such a situation the actuator arrangement may not be able to rotate to effect switching of the selected drive transfer arrangement from a locked to an unlocked configuration. Referring to FIGS. 17a-c presented is an exploded view and an assembled view of a means for causing switching between a locked and unlocked configuration under a higher torque situation. The actuator arrangement in the form as shown of a selection plate 22 is configured to axially deflect (shown in the region 141) to a deflected configuration caused by the shaft of the selected drive transfer arrangement 26 still bearing against the selection plate 22 with significant force. An abutment 143 in the form of a shoulder extends inwardly from the input gear formation 8 (or output gear formation 4 if a hub gearbox). Due to the deflection of the selection plate 22, the abutment causes an obstruction to the selection plate 22 (particularly to a formation 147 on the face of the selection plate 22) resulting from contact with the abutment and causes reversal of the deflection thereby forcing the stubborn drive transfer arrangement to revert to the unlocked configuration. Selection of another gear is then enabled.

Referring to FIG. 18, an alternative version is presented including a rigid selection plate 22 and a thrust plate 145 where the thrust plate which locates the selection plate 22 is spring loaded and therefore is configured to move axially relative to the drive transfer arrangements. The axial movement is caused by the shaft of the selected drive transfer arrangement 26 still bearing against the selection plate 22 with significant force. An abutment 143 in the form of a shoulder extends inwardly from the input gear formation 8. Due to the deflection of the selection plate 22, the abutment causes an obstruction to the selection plate 22 (particularly to a formation 147 on the face of the selection plate 22) resulting from contact with the abutment and causes reversal of the axial movement thereby forcing the stubborn drive transfer arrangement to revert to the unlocked configuration. Selection of another gear is then enabled.

Aspects of the present invention have been described by way of example only and it will be appreciated to the skilled addressee that modifications and variations may be made without departing from the scope of protection afforded by the appended claims.

1. A gearbox for a bicycle comprising:
an input gear configured to receive a drive input and rotate about a first rotation axis in a first plane;
an output gear configured to rotate about a second rotation axis in a second plane different to the first plane;
a plurality of drive transfer arrangements intermediate the input gear and output gear, each of the drive transfer arrangements comprising a first gear engaged with the input gear, a second gear engaged with the output gear and a shaft therebetween, each drive transfer arrangement configurable between a locked configuration whereby rotation of one of the first and second gears causes rotation of the other of the first and second gears such that drive between the input gear and output gear is enabled and an unlocked configuration whereby the first and second gears rotate independently of one another thereby disabling drive from the input gear to the output gear; and
a selection arrangement for selecting one of the plurality of drive transfer arrangements and causing reconfiguration of the selected drive transfer arrangement between the unlocked and the locked configuration.

2. The gearbox for a bicycle according to claim 1, wherein the first gear of each of the drive transfer arrangements is in the first plane and the second gear of each of the drive transfer arrangements is in the second plane.

3. The gearbox for a bicycle according to claim 1, wherein each of the first and second gears on at least one of the drive transfer arrangements has a plurality of teeth for engaging with the respective input and output gears, where the number of teeth on the first gear is different to the number of teeth on the second gear.

4. The gearbox for a bicycle according to claim 1, wherein the gear ratio between the first and second gear of a first drive transfer arrangement is different to the gear ratio of the first and second gear of a second drive transfer arrangement.

5. The gearbox for a bicycle according to claim 1, wherein the first gear of each of the drive transfer arrangements is constantly meshed with the input gear.

6. The gearbox for a bicycle according to claim 1, wherein the second gear of each of the drive transfer arrangements is constantly meshed with the output gear.

7. The gearbox for a bicycle according to claim 1, wherein the second rotation axis is different to the first rotation axis.

8. The gearbox for a bicycle according to claim 1, wherein the first gear and second gear of each of the drive transfer arrangements rotate about a common axis.

9. The gearbox for a bicycle according to claim 1, wherein the selection arrangement comprises an actuator arrangement for causing reconfiguration of the selected drive transfer arrangement from the unlocked to the locked configuration and preferably a controller for controlling the actuator arrangement.

10. The gearbox for a bicycle according to claim 9, wherein the controller comprises a shifter configured to receive a user input for transmitting a signal to the actuator arrangement to effect movement of the actuator arrangement.

11. The gearbox for a bicycle according to claim 1, wherein each of the drive transfer arrangements comprise an individual actuator arrangement, preferably wherein each of the individual actuator arrangements comprise a solenoid.

12. The gearbox for a bicycle according to claim 1, wherein the actuator arrangement comprises a structure rotatably mounted relative to the plurality of drive transfer arrangements, where the structure is arranged to selectively cause reconfiguration of the selected drive transfer arrangement between the locked and unlocked configuration.

13. The gearbox for a bicycle according to claim 1, wherein at least one of the first or second gear is axially moveable between the locked and unlocked configuration.

14. The gearbox according to claim 13, wherein the first and second gear are positioned axially between the structure and a spring.

15. The gearbox according to claim 11, wherein the actuator arrangement is configured to axially deflect to a deflected configuration, and there is further provided an abutment moveable with either the input or output gear, where the abutment and the actuator arrangement are configured to abut in the deflected configuration and force the selected drive transfer arrangement into the unlocked configuration.

16. The gearbox for a bicycle according to claim 1, where each of the drive transfer arrangements are arranged such that one of the first gear or second gear is secured relative to the shaft, and the other of the first or second gear is rotatably mounted relative to the shaft, the drive transfer arrangements further comprising a locking arrangement arranged to releasably engage and disengage the first or second gear that is rotatably mounted to the shaft from the shaft such that relative rotation is enabled when disengaged and disabled when engaged.

17. The gearbox for a bicycle according to claim 16, wherein the locking arrangement comprises one or more locking elements for interlocking the shaft and the first or second gear into the locked configuration and a pin moveable between a first position where the locking elements are biased into engagement with the first or second gear and a second position where the locking elements are released from engagement with the first or second gear.

18. The gearbox for a bicycle according to claim 17, wherein the actuator arrangement comprises a structure rotatably mounted relative to the plurality of drive transfer arrangements, and the structure comprises a plurality of recesses or abutments, where each of the recesses or abutments is paired with a corresponding pin so that in discrete rotational positions of the structure a paired pin is axially displaced upon engagement of the pin with the corresponding paired recess or abutment.

19. The gearbox for a bicycle according to claim 18, where when the structure is in one of the discrete rotational positions only one pin is received into its corresponding paired recess, with none of the other pins received into their corresponding paired recesses.

20. The gearbox for a bicycle according to claim 1, where the input gear comprises an input gear ring, and the output gear comprises an output gear ring where each of the input gear and output gear ring comprise a plurality of engagement teeth.

21. The gearbox for a bicycle according to claim 1, wherein the input gear comprises a coupling arrangement for coupling one or more input shafts to the input gear to transfer the drive input to the input gear.

22. The gearbox for a bicycle according to claim 1, wherein the drive input is a crank arm and/or a motor.

23. The gearbox for a bicycle according to claim 1, where in an unlocked configuration the drive input is transmitted through the first gear of a drive transfer arrangement into the input gear.

24. The gearbox for a bicycle according to claim 21, where the coupling arrangement is configured to further couple to a motor for providing supplementary drive to the input gear.

25. A gearmotor for an electric bicycle comprising:
the gearbox according to claim 1; and
a motor for providing drive to the input gear.

26. The gearmotor for an electric bicycle according to claim 25, further comprising a reduction gear stage to provide drive to the input gear from the motor.

27. A powertrain for an electric bicycle comprising:
the gearmotor according to claim 25;
a sprocket for mounting on a wheel of the bicycle; and
a chain or drivebelt coupled to the output gear and sprocket for transferring drive from the output gear to the sprocket.
